(19) United States
(12) Patent Application Publication
(10) Pub. No.: US 2008/0129175 A1
(43) Pub. Date: Jun. 5, 2008

(54) FILM TYPE FILTER AND PLASMA DISPAY APPARATUS INCLUDING THE SAME

(75) Inventors: SANG-YEOL HUR, Suwon-si (KR); Myun-Gi Shim, Suwon-si (KR); Dong-Gun Moon, Suwon-si (KR); Jun-Kyu Cha, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/941,251

(22) Filed: Nov. 16, 2007

(30) Foreign Application Priority Data
Dec. 5, 2006 (KR) 2006-122593

(51) Int. Cl. H01J 61/40; F21V 11/16; H01J 17/49

(52) U.S. Cl. 313/112; 362/351; 313/113

(57) ABSTRACT

A film type filter includes a base film; an electromagnetic wave shielding layer formed on the base film, and including an electromagnetic shielding portion and a grounding portion; and an external light reflection prevention layer formed on the electromagnetic wave shielding layer, wherein at least a portion of the grounding portion of the electromagnetic wave shielding layer that is not covered by the external light reflection prevention layer is exposed. A plasma display apparatus includes the film type filter.

### CROSS-REFERENCE TO RELATED APPLICATION

This application claims the benefit of Korean Application No. 2006-0122593, filed Dec. 5, 2006, in the Korean Intellectual Property Office, the disclosure of which is incorporated herein by reference.

### BACKGROUND OF THE INVENTION

1. Field of the Invention

Aspects of the present invention relate to a film type filter and a plasma display apparatus including the filter. More particularly, aspects of the present invention relate to a film type filter that can easily shield electromagnetic waves emitted by a plasma display apparatus including the film type filter.

2. Description of the Related Art

Plasma display apparatuses are flat panel display apparatuses that display images using a gas discharge. Plasma display apparatuses have superior properties in terms of brightness, contrast, residual images, and viewing angle and have large screens that are thin and light weight. Therefore, plasma display apparatuses have many advantages as large flat panel display apparatuses.

In a conventional plasma display panel (PDP), discharge electrodes, each including a pair of transparent X electrodes and Y electrodes corresponding to display electrodes, are formed on an inner surface of a front glass substrate, and address electrodes are formed on an inner surface of a rear glass substrate. A sustain discharge occurs between the X and Y electrodes included in the discharge electrodes during operation of the PDP.

When a plasma display apparatus is driven, electromagnetic waves outside of the visible spectrum are emitted from the plasma display apparatus. Such electromagnetic waves may be harmful to human beings and may adversely affect the operation of electronic elements included in the plasma display apparatus.

### SUMMARY OF THE INVENTION

Aspects of the present invention provide a film type filter capable of easily shielding electromagnetic waves emitted by a plasma display apparatus including the film type filter.

According to an embodiment of the present invention, there is provided a film type filter including: a base film; an electromagnetic wave shielding layer formed on the base film, and including an electromagnetic shielding portion and a grounding portion; and an external light reflection prevention layer formed on the electromagnetic wave shielding layer, wherein at least a portion of the grounding portion of the electromagnetic wave shielding layer is not covered by the external light reflection prevention layer and is exposed.

According to an aspect of the present invention, the grounding portion of the electromagnetic wave shielding layer may be located along at least two opposing sides of an outer boundary of the electromagnetic wave shielding portion.

According to an aspect of the present invention, the grounding portion of the electromagnetic wave shielding layer may be formed to surround an outer boundary of the external light reflection prevention layer.

According to an aspect of the present invention, the electromagnetic wave shielding layer may have larger surface area than does the external light reflection prevention layer.

According to an aspect of the present invention, the film type filter may further include: an adhesion layer formed on an opposite surface of the base film from the electromagnetic wave shielding layer.

According to an aspect of the present invention, the adhesion layer may selectively absorb light within a predetermined wavelength range.

According to an aspect of the present invention, the electromagnetic wave shielding portion of the electromagnetic wave shielding layer may be formed as a mesh.

According to an aspect of the present invention, the electromagnetic wave shielding layer may include a conductive metal.

According to an aspect of the present invention, the electromagnetic wave shielding layer may include one selected from the group consisting of Ag, Ni, Cu, Au, Al, and Cr.

According to another embodiment of the present invention, there is provided a plasma display apparatus comprising; a plasma display panel comprising a front panel and a rear panel and a film type filter adhered to the front panel, wherein the film type filter comprises: a base film; an electromagnetic wave shielding layer formed on the base film, and including an electromagnetic shielding portion and a grounding portion; and an external light reflection prevention layer formed on the electromagnetic wave shielding layer, wherein at least a portion of the grounding portion of the electromagnetic wave shielding layer is not covered by the external light reflection prevention layer and is exposed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic exploded perspective view illustrating a film type filter according to an embodiment of the present invention;

FIG. 2 is a plan view of the film type filter of FIG. 1, according to an embodiment of the present invention;

FIG. 3 is a partially cross-sectional view taken along line III-III of the film type filter of FIG. 1, according to an embodiment of the present invention;

FIG. 4 is an enlarged view illustrating part A of FIG. 1, according to an embodiment of the present invention;

FIGS. 5 and 6 are plan views illustrating film type filters according to embodiments of the present invention;

FIG. 7 is a schematic exploded perspective view illustrating a plasma display apparatus including the film type filter of FIG. 1, according to an embodiment of the present invention; and

FIG. 8 is a cross-sectional view taken along line VIII-VIII of the plasma display apparatus of FIG. 7, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

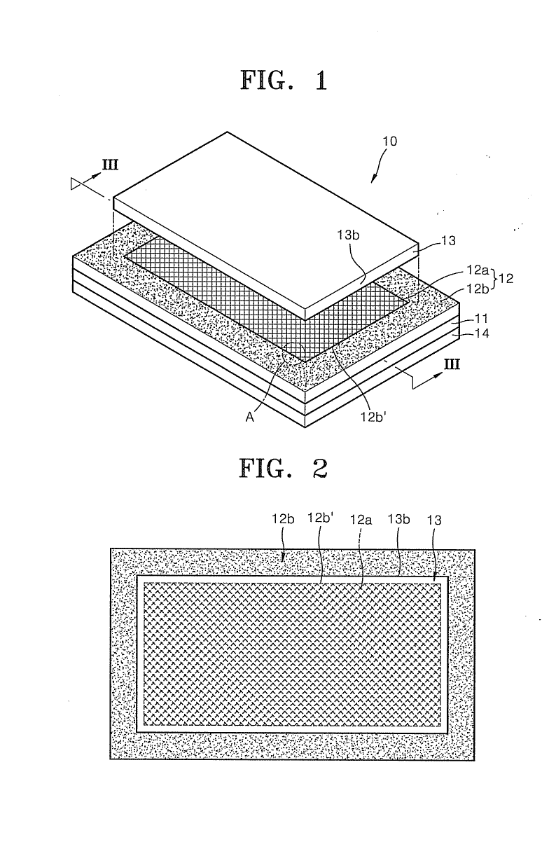

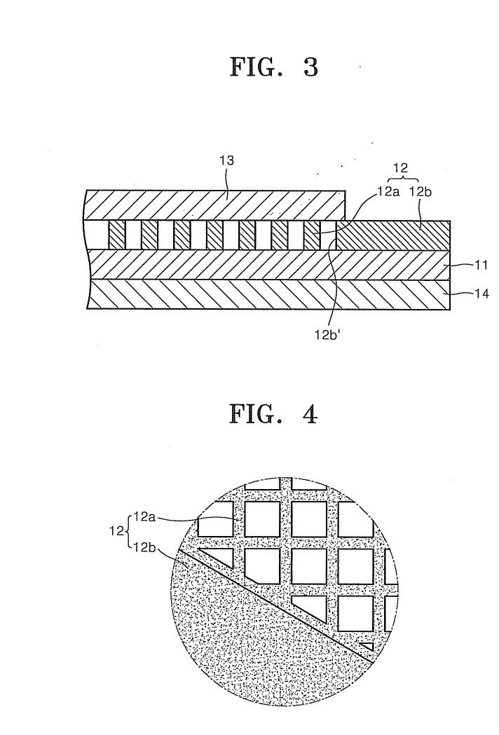

FIG. 1 is a schematic exploded perspective view illustrating a film type filter 10 according to an embodiment of the present invention, and FIG. 2 is a plan view of the film type filter 10 of FIG. 1, according to an embodiment of the present invention. FIG. 3 is a partially cross-sectional view taken along line III-III of the film type filter 10 of FIG. 1, and FIG. 4 is an enlarged view illustrating part A of FIG. 1, according to embodiments of the present invention.

The film type filter 10 includes a base film 11, an electromagnetic wave shielding layer 12, and an external light reflection prevention layer 13. The base film 11 is formed of a transparent material that transmits visible rays of light. The base film 11 can be tinted in order to improve contrast or improve a color temperature, and adjusting tint conditions of the base film 11 can control the transmittance of visible rays of light. As non-limiting examples, the base film 11 can be formed of polyethersulfone (PES), polyacrylate (PAR), polyetherimide (PEI), polyethylene naphthalate (PEN), polyethyleneterephthalate (PET), polyphenylene sulfide (PPS), polyallylate, polyimide, polycarbonate (PC), cellulose tri-acetate (TAC), or cellulose acetate propionate (CAP) or combinations thereof. The base film 11 is formed as a flat plate in the shape of a rectangle as shown in FIG. 1.

The electromagnetic wave shielding layer 12 is formed on the base film 11. The electromagnetic wave shielding layer 12 includes an electromagnetic wave shielding portion 12a that shields electromagnetic waves generated from a plasma display panel and a grounding portion 12b that surrounds the electromagnetic wave shielding portion 12a along the boundaries of the electromagnetic wave shielding portion 12a. Referring to FIG. 4, the electromagnetic wave shielding portion 12a has a rectangular mesh structure. However, the electromagnetic wave shielding portion 12a can have other structures. The electromagnetic wave shielding layer 12 can include a conductive metal selected from the group consisting of Ag, Ni, Cu, Au, Al, and Cr. Herein, generally, when it is mentioned that one layer is formed on a second layer, it is to be understood that the term “formed on” is not limited to the one layer being formed directly on the second layer, but may include instances wherein there is an intervening layer or material between the one layer and the second layer. Moreover, it is to be understood that the term “formed on” may include a layer that is separately fabricated and positioned onto a second layer.

The electromagnetic shielding layer 12 can be formed by stacking metal layers or metal oxide layers, or both alternately. As a non-limiting example, the electromagnetic shielding layer 12 may include three to eleven of such layers. Since the conductive electromagnetic wave shielding layer 12 has a mesh structure, the film type filter 10 can easily block the electromagnetic waves generated from a plasma display apparatus to which the film type filter 10 is attached.

The external light reflection prevention layer 13 is formed on the electromagnetic wave shielding layer 12. An anti-glare layer or a reflection prevention layer can be used as the external light reflection prevention layer 13. Otherwise, both of the anti-glare layer and the reflection prevention layer can be used as the external light reflection prevention layer 13. The anti-glare layer is formed as the external light reflection prevention layer 13 in the current embodiment of the present invention. The external light reflection prevention layer 13 disperses external light incident on a surface thereof, and prevents the peripheral environment around the film type filter 10 from being reflected by the surface of the film type filter 10. The external light reflection prevention layer 13 may include a hard-coating material therein that protects the film type filter 10 from being damaged by external impacts. The hard-coating material of the external light reflection prevention layer 13 can include a polymer as a binder. The polymer can be an acryl-based polymer, an urethane-based polymer, an epoxy-based polymer, a siloxane-based polymer, or an ultraviolet-curing resin such as an oligomer. In order to improve the hardness of the hard-coating material of the external light reflection prevention layer 13, the hard-coating material can further include a silica-based filler. In addition or alternatively, a hard-coating layer can be formed on the external light reflection prevention layer 13 instead of or in addition to forming the hard-coating material in the external light reflection prevention layer 13.

The external light reflection prevention layer 13 may have a thickness of 2.0 μm to 7.0 μm, a hardness of 2H to 3H, and a haze of 1.0% to 3.0%, however, the present invention is not limited thereto.

Referring to FIGS. 1 through 3, the electromagnetic wave shielding layer 12 has a larger surface area than that of the external light reflection prevention layer 13. Therefore, the grounding portion 12b of the electromagnetic wave shielding layer 12 that is not covered by the external light reflection prevention layer 13 is exposed. The grounding portion 12b is formed to surround an outer boundary of the external light reflection prevention layer 13. In detail, as shown in FIG. 2, the grounding portion 12b of the electromagnetic wave shielding layer 12 is disposed to correspond with edges of the external light reflection prevention layer 13, which is formed as a rectangle.

Referring to FIG. 2, outer sides 13b of the external light reflection prevention layer 13 are disposed to correspond with inner sides of the grounding portion 12b. However, the present invention is not limited thereto, and the outer sides 13b of the external light reflection prevention layer 13 can be disposed to correspond with an inner circumferential surface 12b′ of the grounding portion 12b. In other words, the external light reflection prevention layer 13 may fit precisely over the electromagnetic wave shielding portion 12a of the electromagnetic wave shielding layer 12 or the external light reflection prevention layer 13 may cover a larger area than the electromagnetic wave shielding portion 12a such that the external light reflection prevention layer 13 partially overlaps the grounding portion 12b.

According to the film type filter 10 of FIG. 1, since the grounding portion 12b is exposed, a sufficient grounding area of the electromagnetic wave shielding layer 12 can be ensured, and thus, the electromagnetic wave shielding layer 12 can be easily grounded. In particular, since the grounding portion 12b of the electromagnetic wave shielding portion 12 is formed to surround the external light reflection prevention layer 13, the grounding area of the electromagnetic wave shielding layer 12 is large, and the grounding of the electromagnetic wave shielding layer 12 can be easily performed.

The film type filter 10 can further include an adhesion layer 14. The adhesion layer 14 is formed on a surface of the base film 11 that is opposite to a surface facing the electromagnetic wave shielding layer 12. The adhesion layer 14 allows the film type filter 10 to be easily attached to the plasma display apparatus. In addition, the film type filter 10 can be easily attached to other layers due to the adhesion layer 14.

The adhesion layer 14 may include a thermoplastic and UV-curing resin, such as, for example, an acrylate-based resin or a pressure sensitive adhesive (PSA). The adhesion layer 14 can be formed using a deep-coating method or using an air knife method.

The adhesion layer 14 can further include a compound that is able to absorb near-infrared rays. The compound can be, for example, a resin including copper atoms or a resin including a copper compound or a zinc compound. In addition, the adhesion layer 14 can further include a pigment or a dye for color correction. The pigment of the adhesion layer 14 selectively absorbs light within a predetermined wavelength range from among visible light having a wavelength of 400 to 700 nm. In particular, when a discharge occurs in the plasma display panel, undesirable visible light of a wavelength of about 585 nm is emitted due to the presence of neon as the discharge gas. In order to absorb such visible light, the adhesion layer 14 can include a cyanine-based compound, squarylium compound, an azomethine-based compound, a xanthene-based compound, an oxonol-based compound, or an azo-based compound.

The film type filter 10 of the current embodiment can selectively include at least one of an infrared ray shielding layer (not shown) and a color correction layer (not shown). The shielding from infrared rays can be achieved by the electromagnetic wave shielding layer 12 or the adhesion layer 14, however, such shielding of the electromagnetic wave shielding layer 12 or the adhesion layer 14 can be reinforced by forming an additional layer, if necessary. The color correction layer is used when the color purity of the visible light incident from the plasma display apparatus, to which the film type filter 10 of the present invention is applied, is low or when the color temperature needs to be corrected.

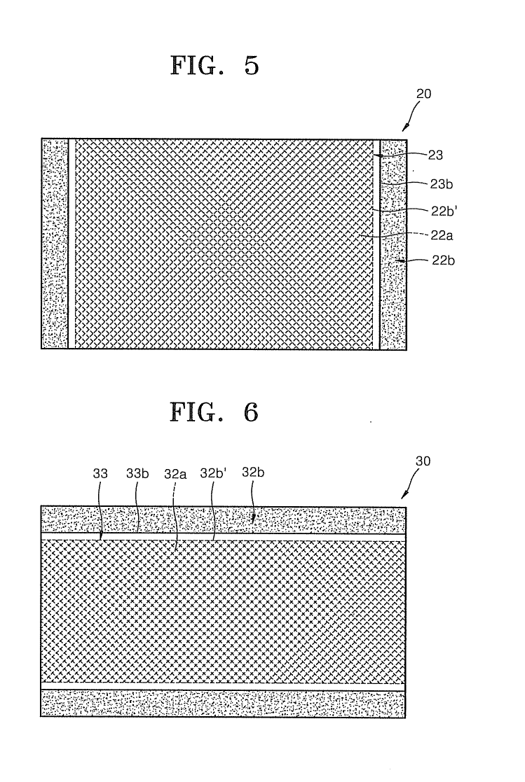

FIG. 5 is a plan view illustrating a film type filter 20 according to another embodiment of the present invention. Hereinafter, elements different from those of the previous embodiment will be described, and like reference numerals denote the same elements.

The film type filter 20 includes a base film 11, an electromagnetic wave shielding layer 22, and an external light reflection prevention layer 23. The electromagnetic wave shielding layer 22 includes an electromagnetic wave shielding portion 22a and a grounding portion 22b. The grounding portion 22b of the electromagnetic wave shielding layer 22 that is not covered by the external light reflection prevention layer 23 is exposed and is formed to correspond with left and right edges of the external light reflection prevention layer 23 as shown in FIG. 5. In the film type filter 20 of the embodiment of FIG. 5, the grounding portion 22b that is exposed corresponds with left and right edges of the external light reflection prevention layer 23, and thus, the electromagnetic wave shielding layer 22 can be easily grounded.

Referring to FIG. 5, an outer side 23b of the external light reflection prevention layer 23 is disposed to correspond with an inner side of the grounding portion 22b of the electromagnetic wave shielding layer 22. However, the present invention is not limited thereto, and thus, the outer side 23b of the external light reflection prevention layer 23 can be disposed to coincide with an inner circumferential surface 22b′ of the grounding portion 22b.

FIG. 6 is a plan view of a film type filter 30 according to another embodiment of the present invention. Hereinafter, elements different from those of the previous embodiment will be described, and like reference numerals denote the same elements.

The film type filter 30 includes a base film 11, an electromagnetic wave shielding layer 32, and an external light reflection prevention layer 33. The electromagnetic wave shielding layer 32 includes an electromagnetic wave shielding portion 32a and a grounding portion 32b. The grounding portion 32b of the electromagnetic wave shielding layer 32 that is not covered by the external light reflection prevention layer 33 is exposed and is formed to correspond with upper and lower edges of the external light reflection prevention layer 33 as shown in FIG. 6. The film type filter 30 of the current embodiment has the grounding portion 32b that is exposed to correspond with upper and lower edges of the external light reflection prevention layer 33, and thus, the electromagnetic wave shielding layer 32 can be easily grounded.

Referring to FIG. 6, an outer side 33b on upper and lower portions of the external light reflection prevention layer 33 is disposed to correspond with the inner sides of the grounding portion 32b. However, the present invention is not limited thereto, and thus, the outer side 33b of the external light reflection prevention layer 33 can be disposed to coincide with an inner circumferential surface 32b′ of the grounding portion 32b.

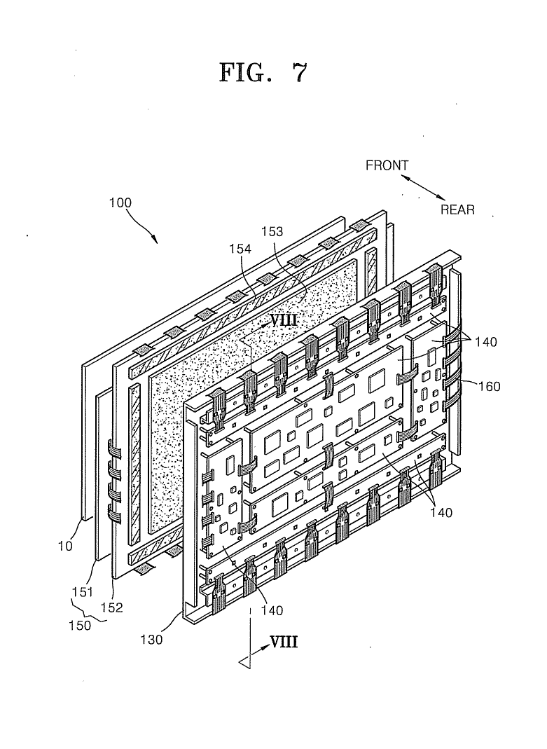

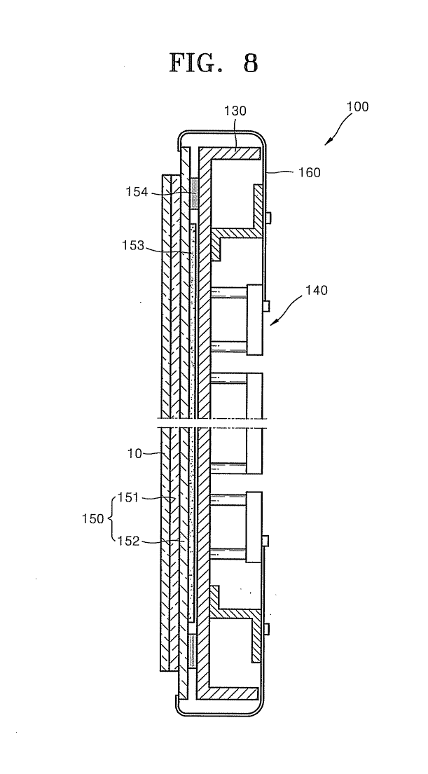

FIG. 7 is a schematic exploded perspective view of a plasma display apparatus 100 including the film type filter 10 of FIG. 1, according to an embodiment of the present invention, and FIG. 8 is a cross-sectional view taken along line VIII-VIII of the plasma display apparatus 100 of FIG. 7, according to an embodiment of the present invention.

The plasma display apparatus 100 includes a plasma display panel 150, a chassis base 130, and circuit units 140. In addition, the film type filter 10 according to an embodiment of the present invention is attached on a front surface of the plasma display panel 150.

The film type filter 10 can be attached to a front surface of the plasma display panel 150 using the adhesion layer 14. Although the film type filter 10 shown in FIG. 1 is described as an example that is applied to the plasma display apparatus 100, the present invention is not limited thereto, and the film type filters 20 and 30 according to FIGS. 5 and 6 can be applied to the plasma display apparatus 100 instead of the film type filter 10.

Electromagnetic waves generated from the plasma display panel 150 during a driving of the plasma display panel 150 are shielded by the electromagnetic wave shielding layer 12 of the film type filter 10, which is formed as a mesh type using a conductive material. Also, infrared rays or neon rays can be shielded by the electromagnetic wave shielding layer 12 of the film type filter 10. Moreover, since the film type filter 10 is directly attached onto the front surface of the plasma display panel 10, the problems relating to generating a dual-image are avoided.

In addition, the film type filter 10 has a lighter weight than a conventional tempered glass filter, and fabrication costs of the film type filter 10 are less.

The plasma display panel 150 includes a front panel 151 and a rear panel 152 displaying images and facing each other in order to be coupled to each other. On the front panel 151 and the rear panel 152, a plurality of electrodes, to which voltages are applied, are arranged respectively. In addition, the electrodes on the front panel 151 and the rear panel 152 may be covered by a dielectric layer. Barrier ribs for defining a plurality of discharge cells, in which a discharge occurs, are formed between the front panel 151 and the rear panel 152, and red, green, and blue phosphor materials are applied on the barrier ribs. In addition, a discharge gas such as Xe is filled in the discharge cells. The chassis base 130 is installed on a rear portion of the plasma display panel 150.

The chassis base 130 supports the plasma display panel 150, and is coupled to the plasma display panel 150 using an adhesive unit, such as, for example, a dual-adhesive tape 154. The chassis base 130 also dissipates heat generated from the plasma display panel 150 externally. To do this, the chassis base 130 can be formed of a material having a high heat dissipating property, such as, for example, aluminum. The chassis base 130 can be fabricated using a casting method or a pressing method.

A thermal transfer medium 153 such as a thermal conductive sheet is inserted between the plasma display panel 150 and the chassis base 130. The thermal transfer medium 153 dissipates heat generated on the plasma display panel 150 to prevent heat from locally concentrating, when the plasma display apparatus 100 is driven. In addition, the thermal transfer medium 153 can sufficiently transfer heat generated from the plasma display panel 150 to the chassis base 130, and thus, heat can be sufficiently dissipated externally.

The circuit units 140 are installed on a rear portion of the chassis base 130. The circuit units 140 generate electric signals for driving the plasma display panel 150 and transmit the electric signals to the plasma display panel 150. A plurality of signal transmission units 160 are disposed between the circuit units 140 and the plasma display panel 150 for connecting the circuit units 140 to the plasma display panel 150.

The signal transmission units 160 electrically connect the circuit units 140 to the plasma display panel 150, and tape carrier packages or flexible printed cables, for example, can be used as the signal transmission units 160.

Electronic devices such as integrated circuits, which turn on/off the signal transmission from the circuit units 140 to the plasma display panel 150, can be mounted on the signal transmission units 160, and the signal transmission units 160 accordingly include wiring portions of a tape type.

A cover plate (not shown) can be disposed on a rear surface of the chassis base 130 in order to cover the signal transmission units 160. The cover plate sufficiently dissipates heat generated from the signal transmission units 160 to the outside, and prevents the signal transmission units 160 from being damaged. The cover plate can be formed of a material including metal.

The plasma display apparatus 100 to which the film type filter 10 of the present invention is applied is described as an example. It is to be understood that the film type filter according to aspects of the present invention can be attached onto front surfaces of various other kinds of display apparatuses.

Electromagnetic waves emitted from the plasma display apparatus can easily be shielded by the film type filter applied to the plasma display apparatus.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A film type filter comprising:
a base film;
an electromagnetic wave shielding layer formed on the base film, and including an electromagnetic wave shielding portion and a grounding portion; and
an external light reflection prevention layer formed on the electromagnetic wave shielding layer,
wherein at least a portion of the grounding portion of the electromagnetic wave shielding layer is not covered by the external light reflection prevention layer and is exposed.

2. The film type filter of claim 1, wherein the grounding portion of the electromagnetic wave shielding layer is located along at least two opposing sides of an outer boundary of the electromagnetic wave shielding portion.

3. The film type filter of claim 2, wherein the grounding portion of the electromagnetic wave shielding layer surrounds an outer boundary of the external light reflection prevention layer.

4. The film type filter of claim 2, wherein the electromagnetic wave shielding portion is rectangular, having longer and shorter opposing sides, and wherein the grounding portion is located along the longer opposing sides.

5. The film type filter of claim 2, wherein the electromagnetic wave shielding portion is rectangular, having longer and shorter opposing sides, and wherein the grounding portion is located along the shorter opposing sides.

6. The film type filter of claim 1, wherein the external light reflection prevention layer fits exactly on the electromagnetic wave shielding portion of the electromagnetic wave shielding layer such that the external light reflection prevention layer does not cover any part of the grounding portion of the electromagnetic wave shielding layer.

7. The film type filter of claim 1, wherein the external light reflection prevention layer has a greater area than does the electromagnetic wave shielding portion of the electromagnetic wave shielding layer such that the external light reflection prevention layer entirely covers the electromagnetic wave shielding portion and partially covers the grounding portion of the electromagnetic wave shielding layer.

8. The film type filter of claim 1, wherein the electromagnetic wave shielding layer has larger surface area than the external light reflection prevention layer.

9. The film type filter of claim 1, further comprising:
an adhesion layer formed on an opposite surface of the base film from the electromagnetic wave shielding layer.

10. The film type filter of claim 9, wherein the adhesion layer selectively absorbs light within a predetermined wavelength range.

11. The film type filter of claim 10, wherein the adhesion layer includes a compound that absorbs near-infrared rays.

12. The film type filter of claim 1, wherein the electromagnetic wave shielding layer comprises stacked metal and/or metal oxide layers.

13. The film type filter of claim 1, wherein the external light reflection prevention layer comprises a hard-coating material.

14. A plasma display apparatus comprising the film type filter according to claim 1.

15. A plasma display apparatus comprising;
a plasma display panel comprising a front panel and a rear panel; and
a film type filter adhered to the front panel,
wherein the film type filter comprises:
a base film;
an electromagnetic wave shielding layer formed on the base film, and including an electromagnetic shielding portion and a grounding portion; and
an external light reflection prevention layer formed on the electromagnetic wave shielding layer,
wherein at least a portion of the grounding portion of the electromagnetic wave shielding layer is not covered by the external light reflection prevention layer and is exposed.

16. The plasma display apparatus of claim 15, wherein the grounding portion of the electromagnetic wave shielding layer is located along at least two opposing sides of an outer boundary of the electromagnetic wave shielding portion.

17. The plasma display apparatus of claim 15, wherein the grounding portion of the electromagnetic wave shielding layer surrounds an outer boundary of the external light reflection prevention layer.

18. The plasma display apparatus of claim 16, wherein the electromagnetic wave shielding portion is rectangular, having longer and shorter opposing sides, and wherein the grounding portion is located along the longer opposing sides.

19. The plasma display apparatus of claim 16, wherein the electromagnetic wave shielding portion is rectangular, having longer and shorter opposing sides, and wherein the grounding portion is located along the shorter opposing sides.

20. The plasma display apparatus of claim 15, wherein the film type filter further comprises an adhesion layer that adheres the base layer of the film type filter to the front panel of the plasma display panel.
